(19) United States
(12) Patent Application Publication
(10) Pub. No.: US 2025/0348268 A1
(43) Pub. Date: Nov. 13, 2025

(54) Improved User Experiences for Fitness Devices

(71) Applicant: Echelon Fitness Multimedia LLC, Chattanooga, TN (US)

(72) Inventors: Lou Lentine, Chattanooga, TN (US); John Santo, Chattanooga, TN (US)

(73) Assignee: Echelon Fitness Multimedia LLC, Chattanooga, TN (US)

(21) Appl. No.: 18/870,935

(22) PCT Filed: Jun. 5, 2023
(86) PCT No.: PCT/US2023/024436

§ 371 Date: Dec. 2, 2024

Related U.S. Application Data
(60) Provisional application No. 63/348,654, filed on Jun. 3, 2022.

(51) Int. Cl. G06F 3/16; A63B 24/00

(52) U.S. Cl. CPC G06F 3/165; A63B 24/0087

(57) ABSTRACT

The example embodiments relate to fitness devices. The example embodiments provide improved user interfaces for interacting with such devices. In an embodiment, a method is disclosed for synchronizing audio with a fitness activity. In an embodiment, a method is disclosed for providing a tag or chase function within a fitness activity. Various embodiments relating to the display of leaderboard data within a fitness activity are likewise disclosed.

### BACKGROUND

Fitness devices have become an increasingly popular means for users to exercise in engaging and competitive settings. Most recently, many such devices have been designed for and installed in residences, hotels, or similar settings. Further, such devices often rely on complex software and graphical user interfaces to present data recorded by the fitness devices and, in some scenarios, synchronized with other devices.

However, visual displays of data on fitness devices present unique challenges not found in other realms of visual displays. Specifically, users are inherently not fully able to engage with a visual display as much as, for example, a stationary user of a laptop or desktop computer can engage with a visual display. That is, users performing fitness activities are, for example, often focused on exercising, unable to physically interact with a computing device, out of breath, or unable to hear (e.g., due to the playing of music via personal audio devices) during fitness activities. Even when not engaging in physical activities, users are frequently not in comfortable positions to interact with an input device. For example, users on stationary bikes are generally in a position to exercise and may not be able to perform extensive user interface operations (e.g., touch operations) without significant effort. Thus, in general, users interacting with visual displays or other computing devices on fitness devices are generally ill-equipped for complex interactions.

Many existing solutions attempt to compensate for this temporarily lowered ability by reducing the functionality of visual displays. For example, large user interface elements are used to enable coarse touch inputs, and few screens are presented to avoid physical exhaustion during interactions. However, such approaches fundamentally reduce the amount and quality of information that can be presented to users of fitness devices.

### BRIEF SUMMARY

In some aspects, the techniques described herein relate to a method including: receiving a target audio feature and a set of intervals; identifying sets of audio tracks based on the target audio feature, a given set of audio tracks corresponding to a respective interval in the set of intervals; generating a playlist based on the sets of audio tracks; and playing back the playlist along with the set of intervals.

In some aspects, the techniques described herein relate to a method, wherein the target audio feature includes a BPM.

In some aspects, the techniques described herein relate to a method, wherein the target audio feature includes a set of BPMs corresponding to the set of intervals.

In some aspects, the techniques described herein relate to a method, wherein identifying sets of audio tracks includes executing a bin-filling algorithm to identify the sets of audio tracks.

In some aspects, the techniques described herein relate to a method, further including prompting a user to save the playlist and saving the playlist to an account of the user.

In some aspects, the techniques described herein relate to a method, wherein playing back the playlist along with the set of intervals includes streaming a fitness activity to a user and streamlining the set of audio tracks while the user operates the fitness activity.

In some aspects, the techniques described herein relate to a method, wherein playing back the playlist includes streamlining the set of audio tracks from a third-party audio provider.

In some aspects, the techniques described herein relate to a method including: receiving, from a first user performing a fitness activity, a tag of a second user performing the fitness activity; generating a tag leaderboard based on first metrics transmitted by a first fitness device of the first user and second metrics transmitted by a second fitness device of the second user; and displaying the tag leaderboard on the first fitness device and the second fitness device.

In some aspects, the techniques described herein relate to a method, further including ranking the first user and the second user based on the first metrics and second metrics, respectively.

In some aspects, the techniques described herein relate to a method, further including generating a target metric for one of the first user and the second user, the target metric based on the ranking of the first user and the second user.

In some aspects, the techniques described herein relate to a method, further including receiving a second tag of a third user performing the fitness activity and adding the third user to the tag leaderboard.

In some aspects, the techniques described herein relate to a method, wherein the second tag is generated by the second user.

In some aspects, the techniques described herein relate to a method, wherein displaying the tag leaderboard includes replacing a global leaderboard.

In some aspects, the techniques described herein relate to a method, wherein receiving a tag includes receiving a selection of a user via a display device communicatively coupled to the first fitness device.

In some aspects, the techniques described herein relate to a system including a fitness device communicatively coupled to a wearable device, the fitness device configured to transmit metrics recorded by the fitness device to the wearable device for presentation to the user.

In some aspects, the techniques described herein relate to a system, wherein the wearable device includes a smart watch.

In some aspects, the techniques described herein relate to a method including recording metrics of a fitness device and transmitting the metrics to a central server; receiving leaderboard data from the central server; and displaying a leaderboard based on the leaderboard data.

In some aspects, the techniques described herein relate to a method, wherein the metrics include one of a resistance, cadence, speed, distance, or duration.

In some aspects, the techniques described herein relate to a method, wherein the leaderboard data includes past performance data of a user of the fitness device.

In some aspects, the techniques described herein relate to a method, further including displaying guidance, the guidance specifying a target metric for a user of the fitness device to reach.

In some aspects, the techniques described herein relate to a method, further including displaying a progress bar, the progress bar having a set of icons corresponding to users in the leaderboard data.

In some aspects, the techniques described herein relate to a method, wherein displaying the leaderboard includes displaying an ordered set of tiles representing users in the leaderboard data.

In some aspects, the techniques described herein relate to a method, further including receiving a selection of a user in the leaderboard and displaying a tag leaderboard.

In some aspects, the techniques described herein relate to a method, further including displaying marker at position relative to the tag leaderboard representing a user's progress with respect to the leaderboard.

In some aspects, the techniques described herein relate to a method, wherein the leaderboard includes a set of tiles wherein at least one tile of the set of tiles corresponds to a user of the fitness device and wherein the at least one tile includes a progress bar having a set of icons corresponding to users in the leaderboard data.

### BRIEF DESCRIPTION OF THE DRAWINGS

FIG. 1 is a block diagram illustrating a fitness system according to some of the example embodiments.

FIG. 2 is a flow diagram illustrating a method for synchronizing audio with a fitness activity according to some of the example embodiments.

FIG. 3 is a flow diagram illustrating a method for providing a tag leaderboard.

FIG. 4 is a user interface diagram of a user interface (UI) displayed on a fitness device.

FIG. 5 is a user interface diagram of a fitness application according to some of the example embodiments.

FIG. 6 is a user interface diagram of a fitness application according to some of the example embodiments.

FIG. 7 is a user interface diagram of a fitness application according to some of the example embodiments.

FIG. 8 is a user interface diagram illustrating a fitness application according to some of the example embodiments.

FIG. 9 is a user interface diagram illustrating a fitness application according to some of the example embodiments.

FIG. 10 is a user interface diagram of a fitness application with a zoomed in view of a leaderboard according to some of the example embodiments.

FIG. 11 is a block diagram of a computing device according to some embodiments of the disclosure.

### DETAILED DESCRIPTION

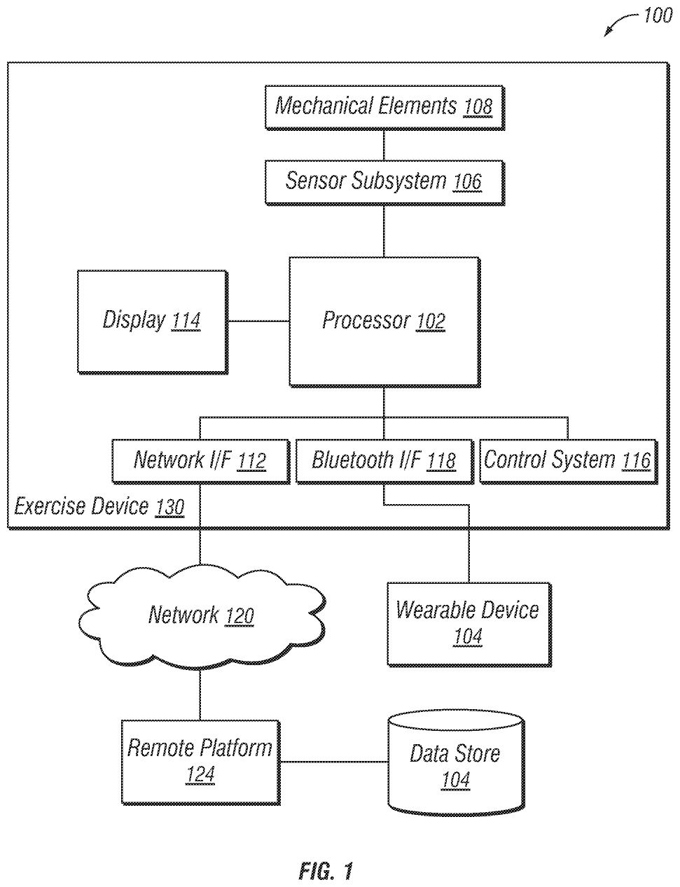

FIG. 1 is a block diagram illustrating a fitness system according to some of the example embodiments.

In an embodiment, a system 100 includes a fitness device 130. The fitness device 130 may include a plurality of mechanical elements 108. The specific mechanical elements 108 of fitness device 130 are not limiting, and various different types of fitness devices may include different mechanical elements 108. For example, a spin or exercise bike may include a flywheel or types of resistance elements. A rowing machine may include a fan or other type of resistance element. A treadmill may include a motor or similar device. Mechanical elements 108 may include additional elements such as physical controls (e.g., handlebars), structural elements, or other types of physical devices. While the following embodiments describe selected physical elements in more detail, any such discussion is not intended to be limiting.

As illustrated, fitness device 130 can include various electronic components. In an embodiment, the fitness device 130 includes a processor 102. The processor 102 can comprise a central processing unit (CPU), graphics processing unit (GPU), microcontroller, or another type of processing device. In some embodiments, the processor 102 can include multiple such processing devices. In some embodiments, the processor 102 can read data from memory or disk (e.g., non-transitory computer-readable storage media) and execute computer program instructions stored thereon. Details on the operation of such operations are provided in the following flow diagrams.

In an embodiment, the processor 102 can receive data from mechanical elements 108 via sensors 106. In an embodiment, sensors 106 can be equipped for any desired mechanical element. For example, a sensor can be figured to monitor a resistance level of a flywheel (e.g., in a spin or exercise bike) or a fan or water container (e.g., in a rowing machine). In an embodiment, sensors 106 generate continuous or periodic data points representing the mechanical state of the fitness device 130 and provide these data points to the processor 102. In some embodiments, processor 102 can receive the data point via a designated interface (e.g., a Peripheral Component Interconnect Express, PCIe, bus, serial peripheral interface bus, etc.). In an embodiment, the sensors 106 can include a weight or pressure sensor. In such an embodiment, the weight or pressure sensor can detect the use of the fitness device 130 by a user. For example, a spin or exercise bike can include such a weight or pressure sensor in a seat element or pedal element to detect when a user is sitting or otherwise engaging with the fitness device 130. Similarly, a treadmill device can include a weight or pressure sensor along the tread to identify when a user is using the fitness device 130.

In an embodiment, the fitness device 130 can be controlled via one or more controls in control system 116. In some embodiments, the control system 116 can comprise a plurality of physical control elements. For example, control system 116 can comprise physical buttons or other types of user input elements to control operations of fitness device 130. In an embodiment, the control system 116 can include a plurality of buttons situated on a handlebar or other mechanical element of the fitness device 130. In some embodiments, the buttons can be configured to transmit interrupt signals to processor 102 to trigger an operation by processor 102. For example, one or more buttons on handlebars can be used to change the resistance level of a programmatically controllable mechanical element of the fitness device 130 (e.g., a flywheel, fan, etc.). Other operating parameters (e.g., treadmill speed, elevation, cadence, split time, heart rate target, etc.) can be used. In some embodiments, the buttons can be used to increment or decrement an operating parameter. In other embodiments, the buttons can be used to load a preset setting for the operating parameters. Alternatively, or in conjunction with the foregoing, buttons situated on handlebars can be used to control the volume output of a speaker connected to processor 102 (not illustrated). In some embodiments, the control system 116 can include other types of input devices such as trackballs, trackpads, scroll wheels, etc. In some embodiments, the control system 116 can include multiple, disparate types of input controls. In some embodiments, the control system 116 can include a voice control system that includes a microphone and speech processor to convert audio into text commands. In some embodiments, a voice control system can be used to allow users to adjust settings of the fitness device 130 (e.g., resistance, incline, etc.) without requiring manual input.

In an embodiment, the fitness device 130 includes a display 114. In some embodiments, display 114 can comprise a flat panel display. In some embodiments, the display 114 can comprise a curved flat panel display. In some embodiments, the display 114 can comprise an organic LED (OLED) display or a similar type of display. In some embodiments, display 114 can be communicatively coupled to the processor 102 via a standard video connection and bus. In an embodiment, the processor 102 can be configured to generate graphics to display on display 114. For example, processor 102 can present user interfaces to a user of the fitness device 130 during operation, as will be discussed in more detail herein.

One example of a user interface comprises a video of an exercise class that can be synchronized and streamed to multiple exercises devices. In some embodiments, the video can be filmed by recording an instructor using a fitness device and then replayed to multiple fitness devices along with operating parameters to use for the fitness devices. In some embodiments, the instructor can be filmed in front of a large screen (e.g., LED display) or another display device that can display content. In some embodiments, this content can comprise music videos or similar types of content.

In an embodiment, the fitness device 130 includes a Bluetooth interface 118 for communicating with nearby electronic devices. In an embodiment, the Bluetooth interface 118 can comprise a device implementing an IEEE 802.15.1 standard or similar short-range wireless technology standard. In an embodiment, the fitness device 130 can communicate with other display devices such as a wearable device 104 via the Bluetooth interface 118. In some implementations, the wearable device 104 can include a smartwatch or similar type of device. In these implementations, the processor 102 can transmit data to the wearable device 104. This data can include current metrics, heartrate data, leaderboard data, or other data of a fitness activity.

In an embodiment, the fitness device 130 can include a network interface 112 to connect to one or more communications networks 120. In an embodiment, the one or more communications networks 120 can include a public Internet or similar type of wide-area network (WAN). In some embodiments, the one or more communications networks 120 can include a local area network (LAN) in addition to (or in place of) a WAN.

In some embodiments, fitness device 130 can communicate with a remote platform 124. In some embodiments, the remote platform 124 can comprise one or more physical or virtual server devices or other computing devices that can receive data recorded by the fitness device 130 and provide data to the fitness device 130. For example, the remote platform 124 can receive operating data captured by sensors 106 and synchronize this data with other fitness devices. For example, the remote platform 124 can provide a streaming or on-demand fitness activity to a set of fitness devices and receive the operating parameters of each device. The remote platform 124 can then broadcast all received data to each fitness device to provide a leaderboard or similar type of visualization. Examples of such visualizations (and the operations of remote platform 124) are provided in commonly-owned applications bearing Ser. No. 63/177,716 and Ser. No. 17/377,552.

In an embodiment, the remote platform 124 can store centralized data in data store 126. Examples of centralized data include user account data, fitness activity data (e.g., exercise class video data, segment data, etc.), as well as historical operating parameter data associated with the performance of fitness activities. The data store 126 may comprise one or more databases or other types of data storage devices.

The fitness device 130 described above can record the operating parameters of the various mechanical elements 108. The fitness device 130 can also provide a rich visual experience via display 114 (e.g., multi-person classes, leaderboard, streaming video, music, etc.). Various aspects of these operations are described in more detail in the following flow diagrams.

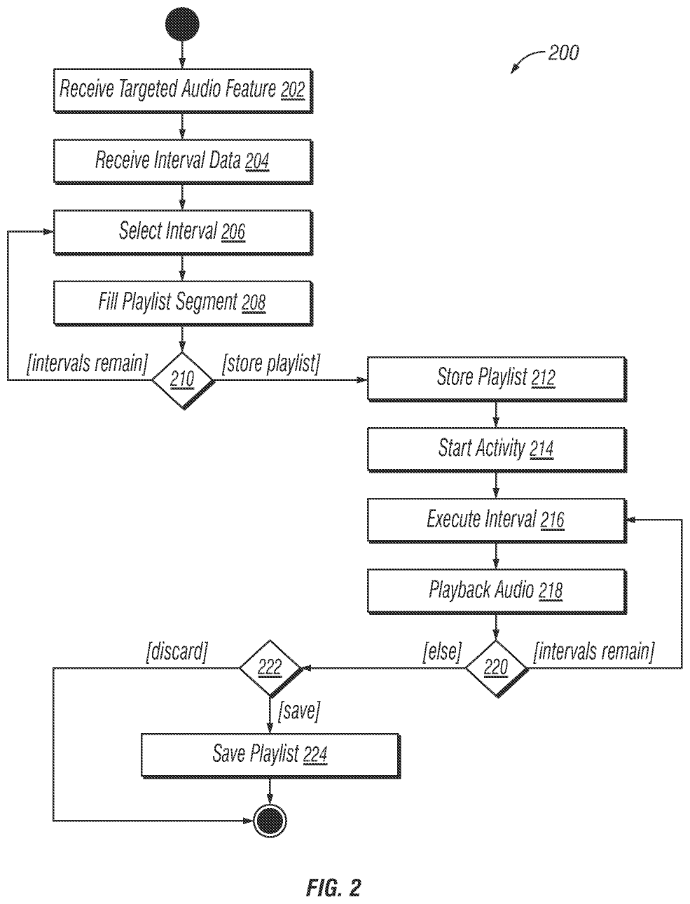

FIG. 2 is a flow diagram illustrating a method for synchronizing audio with a fitness activity.

In step 202, method 200 can include receiving a targeted audio feature. The targeted audio feature can include an intrinsic property of audio. For example, the intrinsic property can include a value for beats per minute (BPM). Method 200 can use other intrinsic properties (e.g., tempo, etc.), and the disclosure is not limited as such. Alternatively, step 202 can include receiving a targeted feature of non-audio data. For example, video data characteristics or image characteristics can be received (e.g., scene types, etc.). As used herein audio tracks can refer to musical audio as well as any other type of audio such as podcasts etc.

A user can manually set the targeted audio feature (e.g., via a BPM selection interface element). For example, prior to starting a fitness activity (e.g., exercise class), the user can select a target BPM for method 200 to use. As will be discussed, in some implementations, step 202 can include receiving multiple targeted audio features.

In step 204, method 200 can include receiving interval data. As used herein, interval data may be a set of durations associated with the fitness activity. For example, a thirty-minute spin class may have four intervals of ten minutes, five minutes, ten minutes, and five minutes. No limit is placed on the arrangement of intervals.

In step 202 and step 204, a single targeted audio feature can be received and used for each interval. For example, if a user sets a target BPM of 480 BPM and the previous example intervals make up the fitness activity, method 200 can apply the 480 BPM feature for each interval. Alternatively, a user can supply more than one targeted feature for each interval. For example, a user can provide a 480 BPM feature for the first interval, a 410 BPM feature for the second interval, a 420 BPM interval for the third interval, and a 90 BPM feature for the fourth interval. In some scenarios, users may set targeted audio features based on a characteristic of the interval. Thus, in the immediately preceding example, the first and third intervals may be active intervals, the second interval may be an active recovery interval, and the fourth interval may be a cooldown interval.

In step 206, method 200 can include selecting a given interval, executing step 208 for the interval, and then repeating the decision in step 210 until all intervals are processed. Thus, as illustrated, method 200 iterates through each interval and performs step 208 for each interval. In some scenarios, if the audio is longer form (e.g., podcasts) method 200 can replace step 206 through step 210 with a single step of identifying a suitable longer form audio file based on the total duration of the fitness activity.

In step 208, method 200 can include filling a playlist segment for the interval. In this step, method 200 identifies audio files (or other multimedia types) to playback during other content (e.g., live streamlining fitness instructor video) of the interval.

In one implementation, step 208 can include first filtering a library of audio tracks based on the target audio feature (e.g., BPM) for the interval to reduce the total number of candidate audio tracks. Alternatively, step 208 can include filtering the audio tracks based on a range of target audio features. For example, step 208 can filter audio tracks within five BPM of the target BPM (e.g., between 475 and 480 BPM). Method 200 may use other tolerances. Next, step 208 can include selecting a fixed number of audio tracks and the total duration of the fixed number of audio tracks matching the duration of the interval selected in step 206. Various strategies can be used to implement the selection of a fixed number of audio tracks.

In one implementation, step 208 can include setting a target average track duration and a tolerance. For example, step 208 can include finding audio tracks from the subset of audio tracks that are between 450 seconds and 210 seconds. Method 200 can then begin selecting tracks from the subset of audio tracks that fall within this range until the total duration of the selected tracks equals or exceeds the interval duration. Since the total duration may exceed the interval duration, during playback, method 200 can fade out or otherwise prematurely end the final audio track exceeding the interval duration.

In another implementation, step 208 can include attempting to match the duration of the selected audio track exactly to the interval duration. Such an implementation may use various bin-packing algorithms (e.g., Next-fit, First-fit, Best-fit, etc.), which are not described in detail herein. Alternatively, aspects of audio tracks can be used to approximate a general solution. For example, step 208 can compute the average track length of the subset of available tracks and perform a floor operation to obtain a maximum length of the first N tracks. For example, if the average track length in the subset of tracks is 3:32, method step 208 can use a value of three minutes as the floor. Next, step 208 can iteratively find tracks within a threshold distance of the mean (e.g., within five seconds) until the interim duration of the selected tracks approaches but does not exceed the interval duration. Thus, considering an interval duration of fifteen minutes (900 seconds), method 200 may select tracks having lengths between 475 seconds and 480 seconds, finding tracks having lengths 475, 477, 480, 475, and 476, for a total of 883 seconds. Next, method 200 may determine if the remaining time is suitable for finding a final track. In some implementations, this may be set as a parameter (e.g., set as within twenty seconds of the average track length). If so, step 208 can include finding a track having the exact length. However, in many scenarios, as in the example, the remaining length will be short (e.g., 17 seconds in the example). In this scenario, step 208 can distribute the remaining time among the selected tracks and re-select tracks. For example, the selected track lengths can be adjusted to 478, 480, 483, 479, and 480. These lengths can then be re-used to select audio tracks to match the interval length.

The foregoing example is simply one implementation of step 208 and, as mentioned, other bin-packing algorithms may be used in place of the above algorithm. In any scenario, step 208 can optionally include ranking the subset of audio tracks (or any search results) to improve the quality of the audio tracks. For example, method 200 can include sorting the audio tracks by the number of streams, number of likes, etc.

Once method 200 selects audio tracks for each interval, method 200 proceeds to step 212, where the selected audio tracks are stored as a playlist. In some implementations, method 200 can execute locally on a fitness device, and step 212 can include caching the playlist on the fitness device. In other implementations, method 200 can be executed on a server, and the resulting playlist can be transmitted to the fitness device for playback. Standard audio (or other multimedia) playlist formats can be used (e.g., M3U).

In step 214, method 200 can include starting the fitness activity. Details of starting a fitness activity are not described in detail herein. In brief, a fitness device starts a fitness activity by initiating a stream or other multimedia content of the fitness activity. In general, a timer or other temporal element can be used to track the progress and state of the fitness activity.

In step 216, method 200 can include executing an interval from the set of intervals. As illustrated, method 200 executes step 218 for each interval until determining in step 220 that no more intervals remain (or the user prematurely exits the fitness activity). In step 218, method 200 plays back the multimedia content of the interval and simultaneously plays back the audio tracks selected in step 208. In some implementations, a third-party audio provider (e.g., SPOTIFY®) can be used to stream audio tracks. In such an implementation, method 200 can issue calls to an application programming interface (API) of such a third-party audio provider to retrieve streaming audio data.

In step 220, after method 200 executes all intervals (and streams all audio) or after the user prematurely exits the fitness activity, method 200 can include prompting the user to save the playlist (step 224) generated in step 208. If the user decides not to save the playlist, method 200 ends. Alternatively, if the user decides to save the playlist, method 200 executes step 222.

In step 222, method 200 can include saving the playlist to an account of the user. In some scenarios, this account can be an account with a third-party audio provider. In such a scenario, step 222 can include providing the listing of tracks to the third-party audio provider via an API call. In some implementations, step 222 can include generating a name and other data (e.g., cover image) for the playlist. As one example, step 222 can use the name of the fitness activity as the name of the playlist and include a stock image or other image associated with the fitness activity as a cover image.

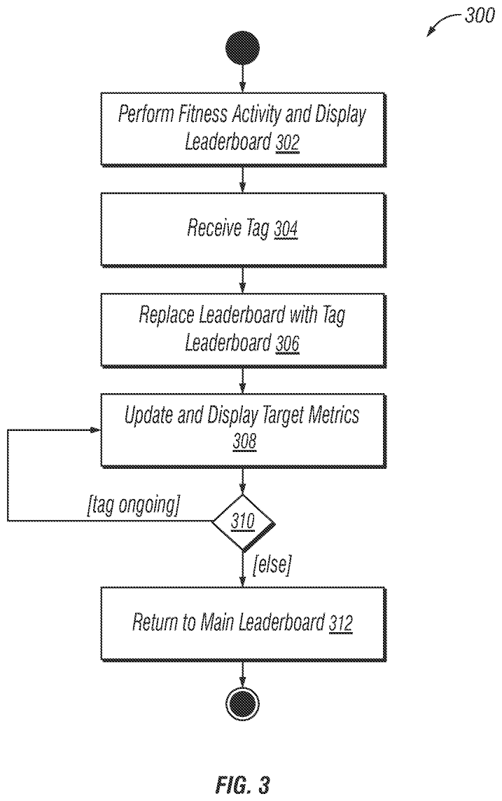

FIG. 3 is a flow diagram illustrating a method for providing a tag leaderboard.

In step 302, method 300 can include performing a fitness activity and displaying a leaderboard. As discussed above, the fitness activity can be, as one example, a multi-person streaming fitness class whereby users perform the activity simultaneously with other users. As part of this fitness activity, streaming video and/or audio can be transmitted to the user via a display device communicatively coupled to a fitness device. Further, during the fitness activity, metrics recorded by mechanical elements of fitness devices can be transmitted to a central server and the central server can maintain an ordered list of all users participating in the fitness activity. This ordered list can then be transmitted as a leaderboard to each user. The central server can update this leaderboard in, or near to, real-time. In some implementations, the leaderboard displayed on the fitness device can include a subset of all users participating in the fitness activity. For example, if the ordered list is ranked by, for example, distance, the first two users who traveled further than a given user and the first five users who traveled less than the user can be displayed. The central server can continuously update this leaderboard to reflect the state of all users relative to the current user.

In step 304, method 300 can include receiving a tag. As used herein, a tag refers to a data structure representing a user interaction with another user. For example, in one implementation, a user can tap or otherwise select a user icon, name, or other indicia displayed on a screen of the fitness device. In response, the fitness device can transmit the identity of the tapped user to the central server. As another example, the fitness device may display graphical depictions (e.g., avatars) of users and the user can tag an avatar to tag a user. In another example, a user can manually specify the user's indicia (e.g., username, name, email) and tag a submit or similar button to tag a user. While the foregoing description describes a single other user being “tagged,” method 300 can include tagging multiple users. In some scenarios, users can be tagged at any time. Thus, if a first user is tagged and method 300 executes the steps following step 306, other users may be tagged and the tag leaderboard (discussed below) updated accordingly. In some scenarios, any user in a tag leaderboard can tag another user, thus the tagging is not limited to one user.

In step 306, method 300 can include replacing the leaderboard displayed in step 302 with a tag leaderboard. The tag leaderboard can comprise a separate user interface element that compares a user of a fitness device with the one or more other users tagged in step 304. In some implementations, the tag leaderboard can similarly present an ordered list of users, however the users in the ordered list are only selected from the tagged users. In some implementations, the tag leaderboard can also depict target metrics for the user using the fitness device. For example, if the users are ordered by average heartrate, the tag leaderboard can display a target heartrate and time to maintain to enable the user to surpass the other users. Similarly, if the users are ranked by total power output, the tag leaderboard can display a target average power output and time period in which to maintain that target to overtake the other users.

In step 308, method 300 can include continuously updating and displaying target metrics and other metrics. As described with respect to step 302, method 300 can continuously receive metrics of the tagged users and the user operating the fitness device and can similarly update the tag leaderboard accordingly. Further, in step 308, any target metrics (e.g., average metric value to maintain over a period of time) can be updated based on the user's output and the other tagged users' outputs.

As illustrated, in step 310, method 300 can include determining if the tag leaderboard should still be shown. For example, method 300 may set a timer for the tag leaderboard thus allowing for “mini” races within a fitness activity. Alternatively, method 300 may await an explicit termination of the tag mode from one or more users displayed on the tag leaderboard. In step 312, method 300 can include displaying the main leaderboard (as discussed in step 302) when the tag leaderboard is completed.

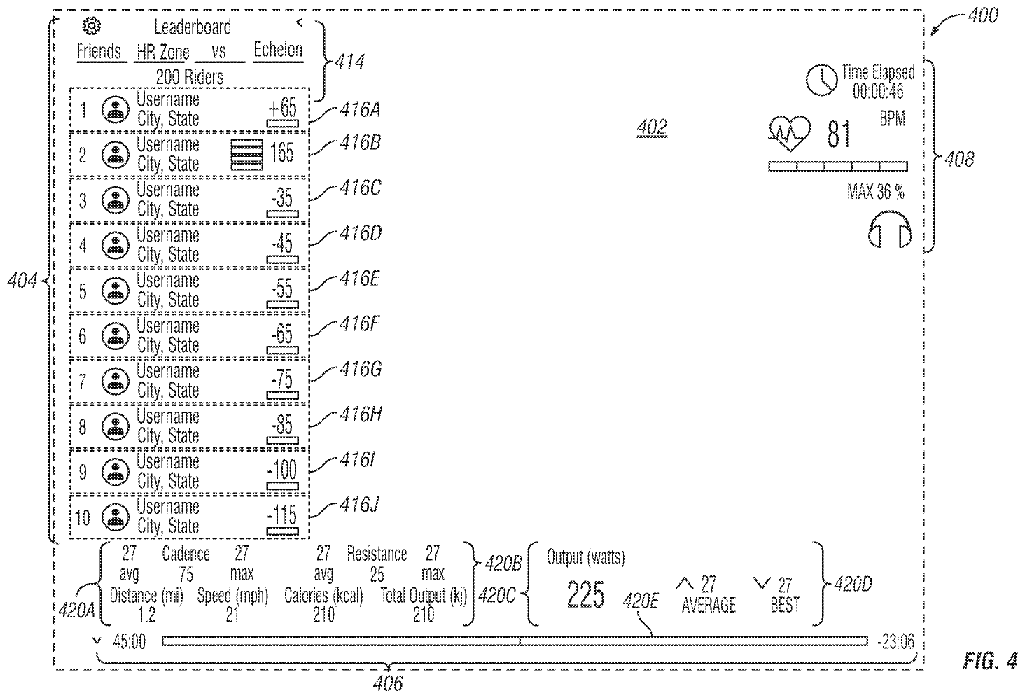

FIG. 4 is a user interface diagram of a user interface (UI) displayed on a fitness device.

A user interface 400 can include a plurality of components, including a main window 402, a leaderboard 404, a status panel 406, and a heads-up display 408. The specific arrangement of the components is not intended to be limiting.

The leaderboard 404 can include a header portion that includes a title label and a plurality of tabs 414. The tabs 414 can allow a user to toggle between various leaderboard views. In the illustrated embodiment, a versus leaderboard view is illustrated. In this view, all users performing the activity (either in real-time or in archived mode) are ranked based on their position in the activity. For example, if the activity is cycling or rowing, the users can be ranked based on their total distance cycled. Other techniques can be used to rank users, and the disclosure is not limited in that regard.

In some embodiments, leaderboard 404 is scrollable. Thus, while only ten users are listed, a user can scroll to view all users in ranked order. In some embodiments, the device implementing the user interface 400 will only load a subset of all riders for display and will issue a network request to pre-load additional riders as the user scrolls (e.g., fifty at a time). In other embodiments, the user interface 400 will pre-load all users to reduce the lag during scrolling.

In the illustrated embodiment, leaderboard 404 includes a plurality of panels 416a-416j, each panel associated with a user. Each panel may include a rank number 118a, a profile picture or icon 118b, descriptive text 118c, a relative position 118d, a current output indicator 118e, and a power meter 118f.

In the illustrated embodiment, the rank number 118a comprises an integer ranking of the users. As illustrated, users are ranked from one to the total number of users. In the illustrated embodiment, this rank number 118a comprises the sorting key when sorting users. In other embodiments, the users are ranked by a metric (e.g., distance) and then assigned a rank number 118a.

In the illustrated embodiment, the profile picture or icon 118b may comprise a user-uploaded image or a stock image or a live image of the user as they engage in the activity. In one embodiment, icon 118b is associated with an image file transmitted to the fitness device implementing the UI. In other embodiments, the icon 118b is associated with a uniform resource locator (URL) that is dynamically downloaded when referenced in the UI. In some embodiments, the icon 118b may be augmented with badges or other indicators. In some embodiments, these badges or other indicators may comprise awards, progress indicators, or other graphics.

In the illustrated embodiment, the descriptive text 118c comprises text associated with a given user. For example, the descriptive text 118c can comprise a username, city, state, or other text data associated with the user.

In the illustrated embodiment, the relative position 118d comprises an integer value that indicates the relative position of users. In the illustrated embodiment, current user panel 416b is associated with a user using the fitness device implementing the user interface 400. In one embodiment, the relative position 118d comprises the total output of a user. In one embodiment, the output of a user refers to a value generated based on the recorded sensor data of the fitness device. For example, an exercise bike may compute an output value based on the revolutions per minute (rpm) and the current resistance level. As another example, a rowing machine may use a stroke rate and split rate to compute an output level. Although output level is used as an example, other comparable values may be used. For example, the relative position 118d may comprise a total traveled distance during an activity, a total time performing the activity, or other value. In general, however, the relative position 118d may comprise an aggregated or total value versus an instantaneous value.

In the illustrated embodiment, panels 416a and 416c through 118j include a current output indicator 118e. In the illustrated embodiment, the current user panel 416b does not include such an indicator. In some embodiments, however, the current user panel 416b may include such an indicator. The current output indicator 118e can comprise a visual indicator of a current output level. In one embodiment, the current output indicator 118e comprises a rectangular (or another shape) solid that changes color based on the instantaneous output of each user. In one embodiment, an instantaneous output is categorized into categories to assist in color determination. For example, an instantaneous output may be categorized as high (red), medium (orange), low (yellow), or idle (green). Thus, the current output indicator 118e changes colors based on the current output of a given user. In this manner, the current outputs of all users can be quickly understood by the current user. In some embodiments, the current output indicator 118e may further be adjusted in other ways based on the current output. For example, the width of the current output indicator 118e may be adjusted in a similar fashion. That is, the width may be adjusted to 400% (high), 75% (medium), 50% (low), or 25% (idle) of the maximum width based on the instantaneous output.

In the illustrated embodiment, the current user panel 416b does not include a current output indicator 118e. By contrast, in the illustrated embodiment, the current user panel 416b includes a power meter 118f. In the illustrated embodiment, the power meter 118f comprises a meter level indicating a user's current output. In some embodiments, the power meter 118f uses the same strategy for indicating current output. However, in the illustrated embodiment, the power meter 118f comprises a vertical stack of bars indicating instantaneous output. Continuing the previous example, in one embodiment, the lowermost bar comprises a green (idle) bar, followed upwardly by an orange bar (low), yellow bar (medium), and red bar (high). As the current user's instantaneous output changes, the appropriate bar is displayed, all bars under the appropriate bar are also displayed, and all bars above the appropriate bar are not displayed.

The user interface 400 can further include a status panel 406. In the illustrated embodiment, status panel 406 includes various metrics 420a-420d measured for a current user's participation in an activity. For example, as illustrated, the status panel 406 includes a user's cadence, resistance level, total output (in watts). As illustrated, status panel 406 may display an instantaneous value for each of these metrics as well as average and maximum recorded values for a given activity. In some embodiments, the status panel 406 further includes data such as distance, speed, calories burned, and a progress bar 420e indicating the user's progress in performing an activity.

The user interface 400 may further include a heads-up display 408. In the illustrated embodiment, the heads-up display 408 may include various details of the activity such as the time elapsed, a heart rate, heart rate training zones, etc.

As discussed, leaderboard 404 comprises one example of a leaderboard. Another example of a leaderboard is further discussed herein.

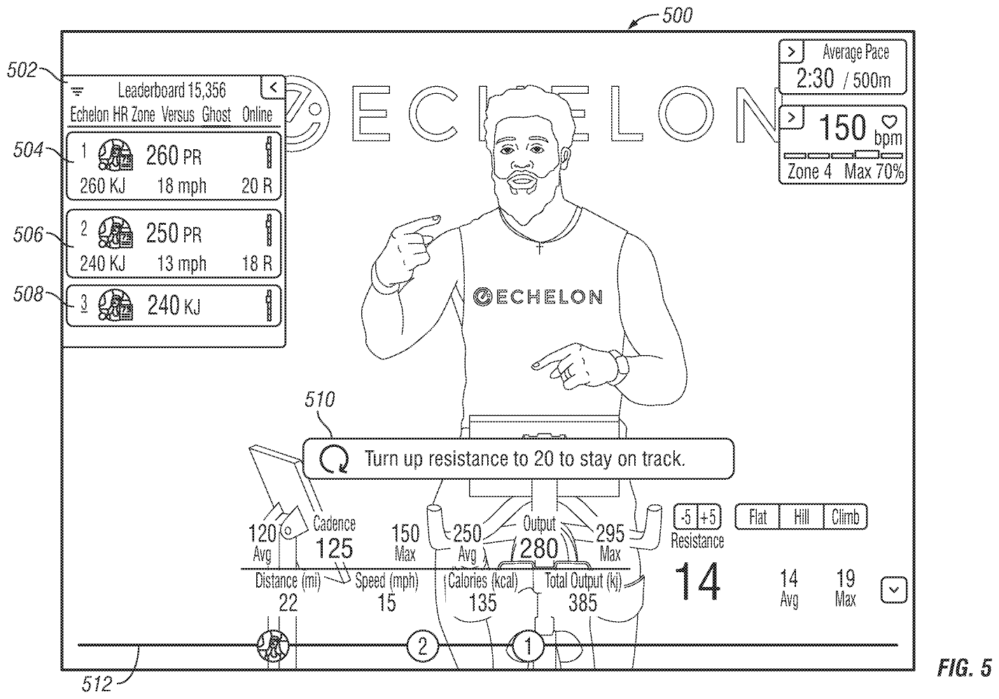

FIG. 5 is a user interface diagram of a fitness application according to some of the example embodiments.

As illustrated, the UI 500 includes a leaderboard 502 displays tile 504, tile 506, and tile 508. In UI 500, each tile 504 and tile 506 correspond to past performances of a user for the fitness activity while tile 508 corresponds to the current performance of the user. In the illustrated UI 500, tile 504 represents a past performance of the user where the use obtained a personal record (PR) of 260. As one example, the value of 260 can represent a total work output during a past performance of the fitness activity, although other metrics could be used (e.g., time, distance, speed, etc.). In some implementations, the leaderboard 502 can include simulated users in lieu of or in addition to past user performances.

The past performance tiles (e.g., tile 504, tile 506) also include target metrics that indicate what a user should do to meet or surpass their past performance. For example, tile 504 indicates that a user should maintain a speed of 18 mph at a resistance level of twenty to reach or surpass the past performance represented in tile 504. Tile 506 includes similar target metrics to meet or surpass the past performance represented in tile 506.

In addition to per-tile target metrics, the UI 500 can include guidance 510 which provides users instructions on how to meet or surpass one or more of the past performances in the tiles. As illustrated, the guidance 510 can include text or interactive controls instructing the user how to reach the past performance. In some implementations, the guidance 510 can be interactive (e.g., an actionable control) that, when interacted with, can automatically change a setting of the fitness device. For example, if the user interacted with guidance 510, a resistance setting can be changed to twenty as prompted.

The above metrics can all be updated in real-time or near to real-time and thus may constantly change as the user performs the fitness activity. In addition to the foregoing, the UI 500 includes a progress bar 512. The progress bar 512 includes icons for each of the tiles in the leaderboard 502 and positions the icons based on the ranking of leaderboard 502 and the distances between the measured and ranked metric (e.g., total output). The foregoing UI 500 provides improved usability of leaderboards and allows users to accurately identify performance objectives to meet goals, in contrast to existing approaches of leaderboards in the art.

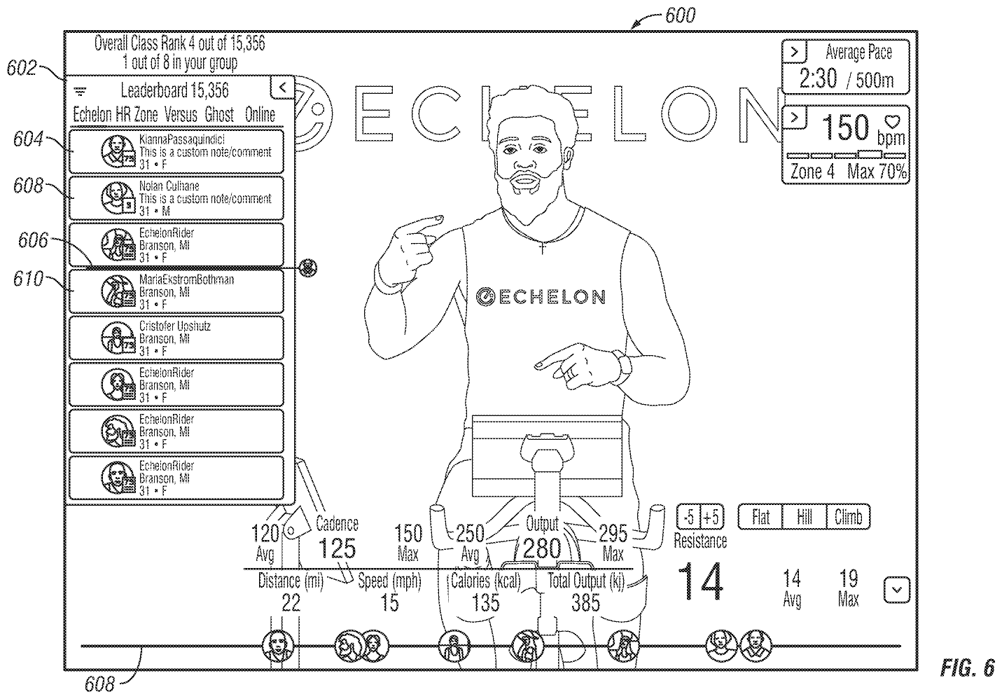

FIG. 6 is a user interface diagram of a fitness application according to some of the example embodiments.

A UI 600 includes a tag leaderboard 602, as described in connection with FIG. 3. In the tag leaderboard 602, the user of the fitness device displaying UI 600 is depicted in tile 604. As indicated on the top of UI 600, the user is participating in both a global leaderboard (not visible) and is placed “4 out of 15,356.” However, the user is simultaneously participating in a smaller group leaderboard (tag leaderboard 602).

In tag leaderboard 602, the user's position (represented as tile 604) is displayed in relation to other users (e.g., the user represented by tile 608). As illustrated, the user is position “1 out of 8” in the group of users. In some scenarios, the users in the group may be formed via tagging, as described in FIG. 3. In addition to displaying the tag leaderboard 602, the UI 600 also includes a progress bar 608 that illustrates the group horizontally and spaces icons representing each user based on their distances between one another. Both tag leaderboard 602 and progress bar 608 may be updated in real-time or near to real-time based on recorded metrics.

In addition to displaying the users position in a smaller group, the UI 600 also includes a marker 606 that represents the user's position in the global leaderboard. The marker 606 can be positioned at a position relative to the user's global position. In some scenarios, the marker 606 can be positioned based on the size of the tiles. Specifically, since the user is in fourth place, the marker 606 is placed at the top of the fourth user tile 610 in the tag leaderboard 602. However, in some scenarios, the position of the user globally may be significantly larger than the number of users in the tag leaderboard 602. For example, the position of the user represented by tile 604 may be 5,000. In such a scenario, the marker 606 can be replaced between the top of tag leaderboard 602 and bottom of tag leaderboard 602 based on computing what percentage of the height corresponds to the user's position. For example, if the user is 5,000 out of 15,356, the user is approximately behind 32% of the global group and ahead of 64% of the global group (5,000/15,356). If the height of the tag leaderboard 602 is 500 pixels, the marker 606 can be positioned 160 pixels from the top of the tag leaderboard 602 (e.g., 32% of 500 pixels). As such, the user can simultaneously view their position in the tag leaderboard 602 (and the corresponding progress bar 608) as well as with respect to the global leaderboard. In some implementations, the UI 600 can include a control to allow the user to toggle between a global leaderboard (depicted in FIG. 4) and the tag leaderboard 602.

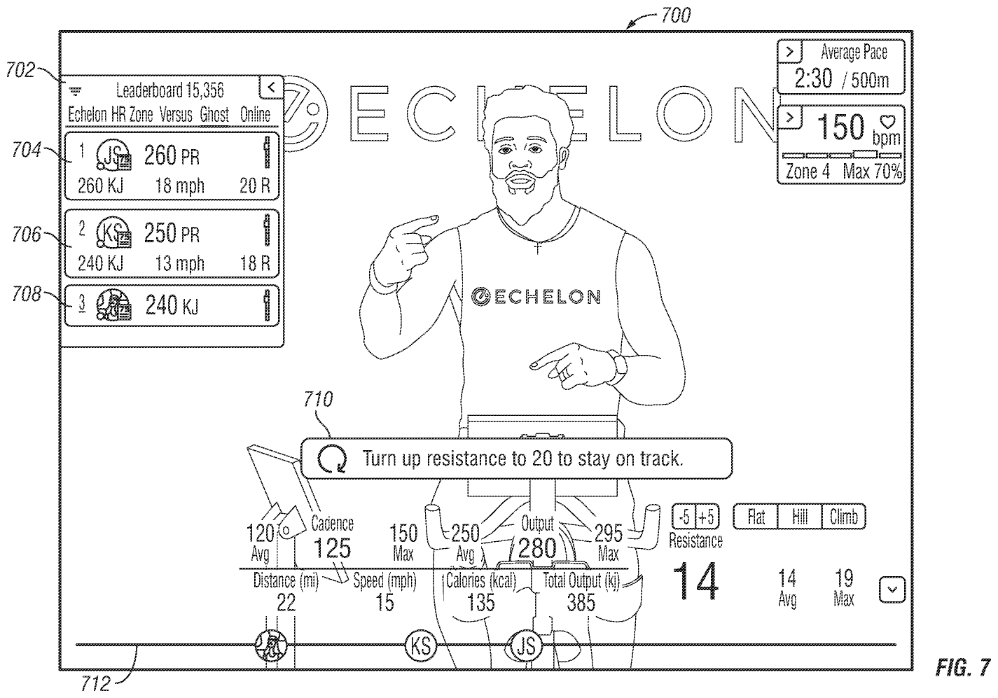

FIG. 7 is a user interface diagram of a fitness application.

The UI 700 is similar to that of UI 500 and details of the description of FIG. 5 is incorporated in its entirety. In contrast to UI 500, UI 700 includes data from other users and not only the active user's past performances. Specifically, tile 704 and tile 706 both represent other users performing the same fitness activity as the active user performing the fitness activity represented by tile 708. In some scenarios, this other user data can be live data (i.e., users actively performing the same activity at the same time as the user represented in tile 708). Alternatively, or in combination, the other user data can include past performances of other users of the fitness activity performed by the user represented in tile 708.

In this manner, the UI 700 can allow a user to gauge their progress against other users (either globally or in a tagged group). Like UI 500, the UI 700 also includes guidance 710 and a progress bar 712 which operate similarly to guidance 510 and progress bar 512, albeit with other user data and not past performance data.

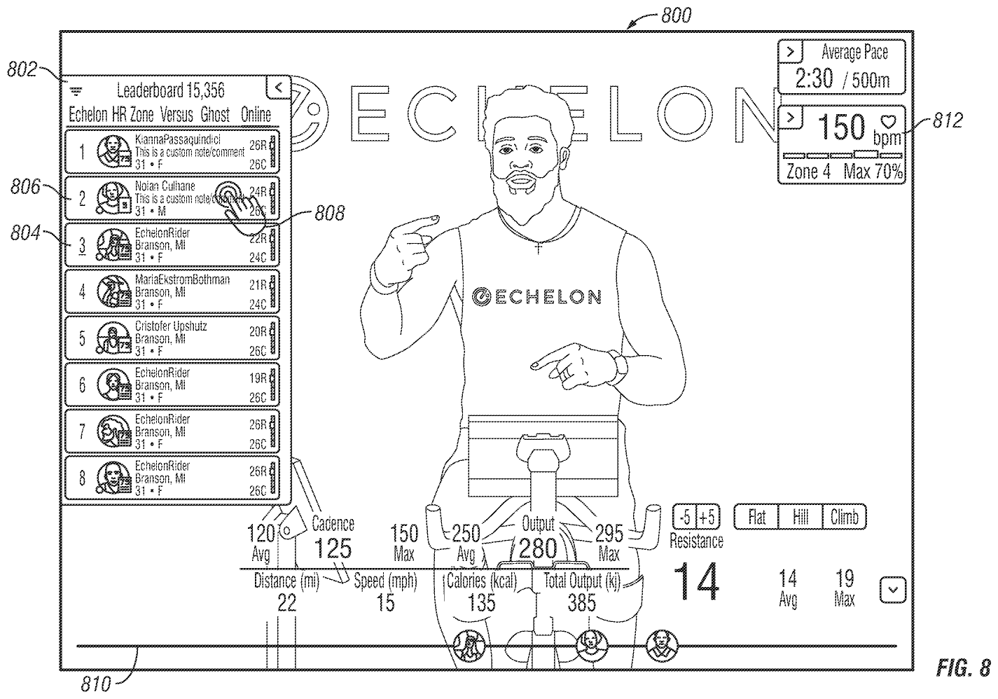

FIG. 8 is a user interface diagram illustrating a fitness application.

In UI 800, a global leaderboard 802 is depicted. In some deployments, UI 800 may comprise a default view during a fitness activity (e.g., exercise class). As illustrated in global leaderboard 802, users are ranked according to a configured metric (e.g., total output, speed, distance, etc.). Each user is associated with a tile. For example, the user operating a fitness device displaying 800 is associated with active user tile 804. Each tile includes one-line representations of metrics (e.g., “21R” indicating a resistance level of 21 or “24C” representing a cadence of 24). Each tile includes a meter on the rightmost side indicating the user's heart rate zone based on the measured heart rate (in heart rate zone monitor 812). As illustrated, the heart rate zone monitor 812 receives the user's heart rate and maps a current heart rate to one or more “zones” based on the received heart rate. The UI 800 also includes a progress bar 810 illustrating the position of the active user with respect to other users. In some implementations, the progress bar 810 may only display a small number of users ahead of the active user and, in some implementations, a small number of users behind the active user to conserve space.

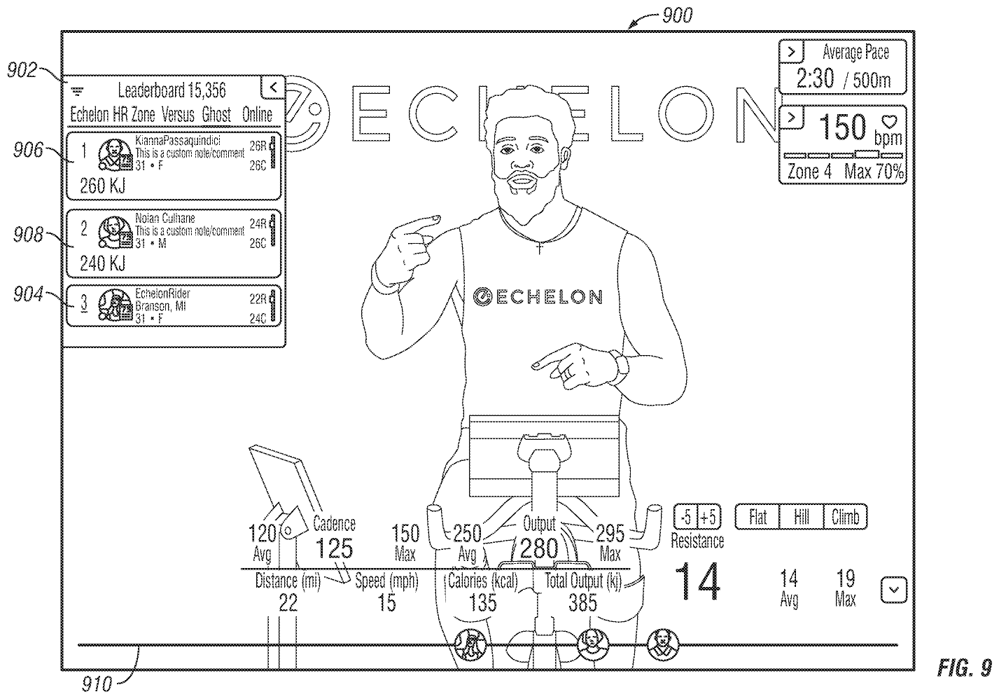

In UI 800, the active user (represented by active user tile 804) can select another user (e.g., the user represented by tile 806). In response, the UI 800 can change to a tag leaderboard format as depicted in FIG. 9.

FIG. 9 is a user interface diagram illustrating a fitness application.

UI 900 illustrates a tag leaderboard 902 displayed after the user selects a user (e.g., the user represented by tile 806 of FIG. 8). As illustrated, the global leaderboard 802 is replaced with a tag leaderboard 902 that includes those users (e.g., the users represented by tile 906 and 908) selected by the active user (e.g., the user represented by active user tile 904). As discussed with respect to FIG. 5, these users are ranked by a central server against each other (or are extracted from a global ranking). Details of tiles were provided in FIG. 5 and are not repeated herein. In brief, each tile for each user includes an icon, name, one-line representations of metrics (e.g., R for resistance, C for cadence), biographical text, age, gender, etc. or other demographic data. Each tile also includes target metrics for the active user to obtain to surpass the other users (as represented in tag leaderboard 902 or progress bar 910. In UI 900, an alternative tile format is depicted that includes the target distance (in meters) to obtain.

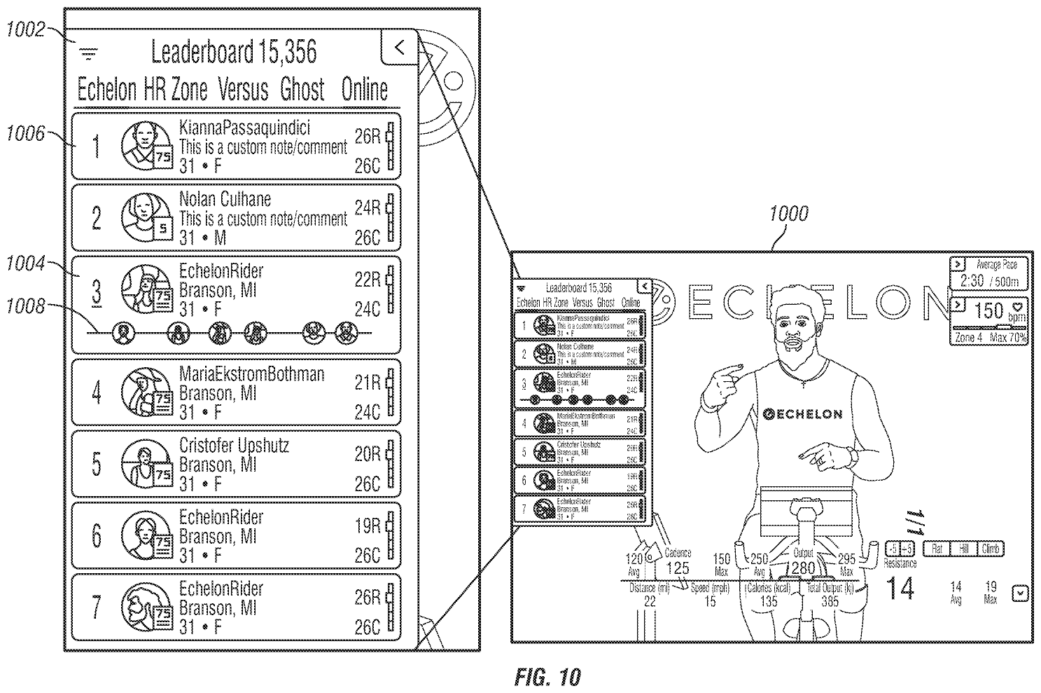

FIG. 10 is a user interface diagram of a fitness application with a zoomed in view of a leaderboard.

In UI 1000, a leaderboard 1002 is included. In contrast to previous figures, the UI 1000 may not include a progress bar or guidance text. As illustrated in the zoomed in view of the leaderboard 1002, a set of users are ranked based on a metric (e.g., total output). An active user represented by active user tile 1004 is depicted relative to other users such as the user represented by tile 1006. The appearance of active user tile 1004 differs from tile 1006 as it includes an in-tile progress bar 1008. The in-tile progress bar 1008 is similar to other progress bars discussed in the preceding figures, however it is embedded only within the active user tile 1004 and thus does not occupy a lower portion of the screen as progress bar 512, progress bar 608, progress bar 712, progress bar 810, or progress bar 910 do.

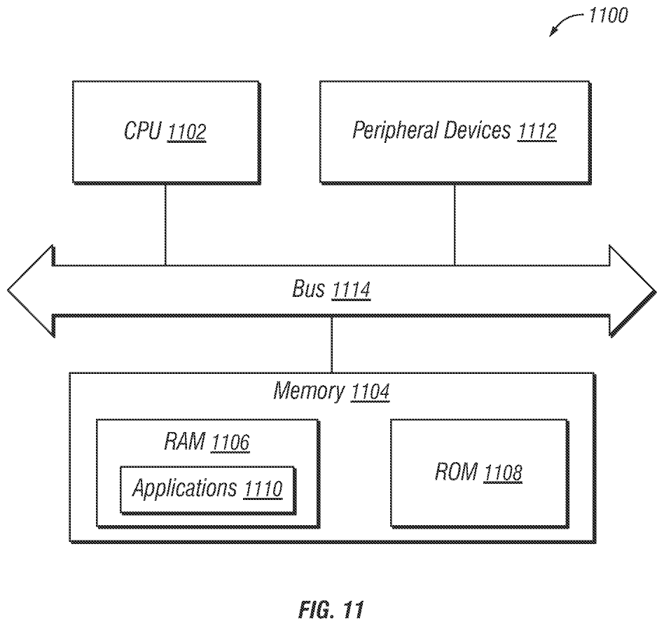

FIG. 11 is a block diagram of a computing device according to some embodiments of the disclosure.

As illustrated, the device 1100 includes a processor or central processing unit (CPU) such as CPU 1102 in communication with a memory 1104 via a bus 1114. The device also includes one or more input/output (I/O) or peripheral devices 1112. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 1102 may comprise a general-purpose CPU. The CPU 1102 may comprise a single-core or multiple-core CPU. The CPU 1102 may comprise a system-on-a-chip (SoC) or a similar embedded system. In some embodiments, a graphics processing unit (GPU) may be used in place of, or in combination with, a CPU 1102. Memory 1104 may comprise a non-transitory memory system including a dynamic random-access memory (DRAM), static random-access memory (SRAM), Flash (e.g., NAND Flash), or combinations thereof. In one embodiment, bus 1114 may comprise a Peripheral Component Interconnect Express (PCIe) bus. In some embodiments, bus 1114 may comprise multiple busses instead of a single bus.

Memory 1104 illustrates an example of non-transitory computer storage media for the storage of information such as computer-readable instructions, data structures, program modules, or other data. Memory 1104 can store a basic input/output system (BIOS) in read-only memory (ROM), such as ROM 1108, for controlling the low-level operation of the device. The memory can also store an operating system in random-access memory (RAM) for controlling the operation of the device

Applications 1110 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 1106 by CPU 1102. CPU 1102 may then read the software or data from RAM 1106, process them, and store them in RAM 1106 again.

The device may optionally communicate with a base station (not shown) or directly with another computing device. One or more network interfaces in peripheral devices 1112 are sometimes referred to as a transceiver, transceiving device, or network interface card (NIC).

An audio interface in peripheral devices 1112 produces and receives audio signals such as the sound of a human voice. For example, an audio interface may be coupled to a speaker and microphone (not shown) to enable telecommunication with others or generate an audio acknowledgment for some action. Displays in peripheral devices 1112 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 1112 may comprise any input device arranged to receive input from a user. An illuminator in peripheral devices 1112 may provide a status indication or provide light. The device can also comprise an input/output interface in peripheral devices 1112 for communication with external devices, using communication technologies, such as USB, infrared, Bluetooth™, or the like. A haptic interface in peripheral devices 1112 provides tactile feedback to a user of the client device.

A GPS receiver in peripheral devices 1112 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 11, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
receiving a target audio feature and a set of intervals;
identifying sets of audio tracks based on the target audio feature, a given set of audio tracks corresponding to a respective interval in the set of intervals;
generating a playlist based on the sets of audio tracks; and
playing back the playlist along with the set of intervals.

2. The method of claim 1, wherein the target audio feature comprises a BPM.

3. The method of claim 1, wherein the target audio feature comprises a set of BPMs corresponding to the set of intervals.

4. The method of claim 1, wherein identifying sets of audio tracks comprises executing a bin-filling algorithm to identify the sets of audio tracks.

5. The method of claim 1, further comprising prompting a user to save the playlist and saving the playlist to an account of the user.

6. The method of claim 1, wherein playing back the playlist along with the set of intervals comprises streaming a fitness activity to a user and streamlining the set of audio tracks while the user operates the fitness activity.

7. The method of claim 1, wherein playing back the playlist comprises streamlining the set of audio tracks from a third-party audio provider.

8-23. (canceled)

24. A non-transitory computer readable storage medium for tangibly storing computer program instructions executable by a computer processor to implement any of the foregoing methods.

25. A device comprising a processor configured to execute any of the foregoing methods.
